(19) United States
(12) Patent Application Publication
(10) Pub. No.: US 2016/0183585 A1
(43) Pub. Date: Jun. 30, 2016

(54) System for Induction Heating of Metal Containers Using Batch Processing

(71) Applicant: Silgan Containers LLC, Woodland Hills, CA (US)

(72) Inventors: Alvin Widitora, Los Angeles, CA (US); Douglas C. Miller, San Ramon, CA (US); George Sadler, Geneva, IL (US); Rowdy Holstine, Hartford, WI (US); Richard Alan Patterson, Pflugerville, TX (US); Lawrence R. Gravell, Georgetown, TX (US); James R. Maunder, Austin, TX (US); Joe A. Ornelas, Austin, TX (US); Stephen M. Manifold, Austin, TX (US); Frank Zeiler, Austin, TX (US); Rodney Jose Allen, Pflugerville, TX (US); Steven DeLeon, Austin, TX (US)

(21) Appl. No.: 15/062,470

(22) Filed: Mar. 7, 2016

Related U.S. Application Data
(63) Continuation of application No. PCT/US2015/042751, filed on Jul. 29, 2015.
(60) Provisional application No. 62/031,010, filed on Jul. 30, 2014.

(51) Int. Cl. A23L 3/00; A23L 3/10; A23L 3/005

(52) U.S. Cl. CPC A23L 3/001; A23L 3/005; A23L 3/10; A23V 2002/00

(57) ABSTRACT

A system is provided for heating batches of sealed, metal cans containing a food product. The system includes a pressure chamber, an induction coil, a can support, a sealing device, a power supply, an air pressure source, and a drive. The pressure chamber has an opening. The induction coil is supported within the pressure chamber. The can support is for engaging and rotating a plurality of sealed, metal cans, at least a portion of the can support being movable through the opening from a first position outside of the chamber to a second position within the chamber adjacent to the induction coil and being rotatably supported within the chamber. The sealing device seals the pressure chamber when the can support is within the chamber. The power supply is coupled to the induction coil to energize the coil to apply an alternating current to the coil to induce a current into the metal cans which heats the food product of the metal cans. The air pressure source is coupled to the pressure chamber to pressurize the chamber during energization of the induction coil. The drive is coupled to the can support which rotates the can support during energization of the induction coil.

### CROSS-REFERENCE TO RELATED PATENT APPLICATION

This application is a continuation of International Application No. PCT/US2015/042751 filed on Jul. 29, 2015 which claims the benefit of and priority to U.S. provisional application 62/031,010 filed on Jul. 30, 2014, which are incorporated herein by reference in their entireties.

### BACKGROUND OF THE INVENTION

Many food products packaged in steel, cylindrical cans with flat panel ends (e.g. sanitary, easy-open, etc.) must be sterilized after filling and closing by raising the temperature of the food product in the can to between 250° F. and 270° F., and held at that temperature for a period of time dependent upon the food product in the can. This heating process creates vapor pressure in the can that will permanently deform or rupture the can unless the outside of the can is properly supported during heating.

Traditionally, sterilization of food products in cans has been done in large steam-heated and pressurized retorts. In some retort processes, the cans are sterilized in batches, and in other processes, the cans move through the retorts continuously, passing through first sets of pressure locks from atmospheric pressure in the can plant to elevated steam pressures in the retort, and then through second sets of pressure locks back to atmospheric pressure. Although steam retort processing of canned food is known for sterilizing food products, other methods have been sought that may provide energy and space savings advantages, and that may better preserve the fresh taste of the food product.

One alternative method for sterilizing food product inside steel cans uses magnetic induction heating (“MIH”) of the can body as the heat source instead of the steam method used in retort systems. In this method, cans are placed inside a magnetic field generated by an adjacent or surrounding induction coil. Eddy currents created in the steel can body generate heat in the steel can body, which in turn heats the food product inside the can to sterilization temperatures.

### SUMMARY OF THE INVENTION

One embodiment of the invention relates to a system for heating batches of sealed, metal cans containing a content, such as a food product. The system includes a pressure chamber, an induction coil, a can support, a sealing device, a power supply, an air pressure source and a drive. The pressure chamber has an opening. The induction coil is supported within the pressure chamber. The can support is for engaging and rotating a plurality of sealed, metal cans, at least a portion of the can support being movable through the opening from a first position outside of the chamber to a second position within the chamber adjacent to the induction coil and being rotatably supported within the chamber. The sealing device seals the pressure chamber when the can support is within the chamber. The power supply is coupled to the induction coil to energize the coil to apply an alternating current to the coil to induce the current into the metal cans which heats the food product of the metal cans. The air pressure source is coupled to the pressure chamber to pressurize the chamber during energization of the induction coil. The drive is coupled to the can support which rotates the can support during energization of the induction coil.

Another embodiment of the invention relates to a system for heating batches of sealed, metal cans containing a food product. The system includes a first plurality of heating induction heating arrangements, a power supply, an air pressure source and a drive system. The first plurality of heating induction heating arrangements each heat a plurality of sealed, metal cans. The first plurality of heating induction heating arrangements each include a pressure chamber, an induction coil, a can support and a sealing device. The pressure chamber has an opening. The induction coil is supported within the pressure chamber. The can support is for engaging and rotating the sealed, metal cans, at least a portion of the can support being movable through the opening from a first position outside of the chamber to a second position within the chamber adjacent to the induction coil and being rotatably supported within the chamber. The sealing device seals the pressure chamber when the can support is within the chamber. The power supply is coupled to the induction coils to energize the coils to apply an alternating current to the coils to induce the current into the metal cans which heats the food product of the metal cans. The air pressure source is coupled to the pressure chambers to pressurize the chambers during energization of the induction coil. The drive system is coupled to the can supports to rotate the can supports during energization of the induction coils.

Another embodiment of the invention relates to a method for induction heating batches of sealed, metal cans containing content which creates pressure in the cans when the cans are heated. The method includes the steps of inserting a plurality of metallic cans into a first pressure chamber including a first magnetic coil arrangement located adjacent to the sealed cans, the chamber being located at a first location, applying electrical energy to the first magnetic coil arrangement while simultaneously increasing the pressure in the pressure chamber and agitating the cans in the pressure chamber, removing electrical energy from the first magnetic coil arrangement, cooling the cans with water while simultaneously reducing the pressure in the pressure chamber and removing the cans from the pressure chamber.

Alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a multiple can induction heating system;

FIG. 2 is a side view of the multiple can induction heating system;

FIG. 3 is a rear view of the multiple can induction heating system;

FIG. 4 is a cross-sectional view of a support arrangement taken along line 4-4 in FIG. 3;

FIGS. 5A-5D are perspective views of a plurality of bottom halves of a pressure rotating tube being inserted into the support arrangement in the multiple can induction heating system;

FIG. 6 is a perspective view of a top half of the pressure rotating tube;

FIG. 7 is a cross-sectional view of the bottom half and top half of the pressure rotating tube engaged with each other located in a pressure chamber of the support arrangement taken along line 7-7 in FIG. 3;

FIG. 8 is a schematic diagram of the support arrangements positions in the multiple can induction heating system; and

FIG. 9 is a flow-diagram showing a method for heating multiple cans according to an exemplary embodiment.

### DETAILED DESCRIPTION

The system described in detail below provides rapid and energy-efficient heating of filled and sealed ferrous metal cans/containers which serves to heat the content (e.g. soup, vegetables, chili, canned meat, ravioli, etc.) of the filled can. The energy which generates the heat is provided by an energized induction coil positioned to induce a current into the ferrous metal material of the can. This current causes heating of the metal material. To facilitate the transfer of heat energy to the content, the cans are agitated using various types of motion such as rotation at angular velocities which are selected, in part, based upon the particular content of the can. In addition to rotating a can in forward and backward directions while it is being heated by the coil, the can may be shaken back and forth, parallel to, and/or normal to its cylindrical axis. The more aggressive the agitation and rotation used, the better the mixing and heat transfer/conduction from the inside of the can body to the contents of the can. By accurately controlling the agitation of the cans, the rate of heating and/or cooling the cans can be optimized without burning the contents that are inside the heated can. In the exemplary embodiment, the most efficient heat transfer from the induction coils to the contents of the can in the system may rotate the cans both in the forward and backward directions, changing rotational directions as often as every 3 seconds, at a maximum speed of 250 rpms. In alternative embodiments, optimal heat transfer from the induction coils to the contents of the can may be dependent upon the direction of rotation, time of agitation, speed of agitation, axis of can rotation, the size of the cans being heated and the contents of the cans.

The system also provides for the control of MIH to improve the food sterilization process. The system also provides MIH coils and electrical energy frequency control to permit customization of heating to particular can sizes and contents. By accurately controlling the can body temperature and/or temperature vs time profile in an MIH sterilization process, the speed of sterilization can be optimized without burning the contents that are in contact with the inside of a heated can. Contents being burned during sterilization will typically change/degrade the smell, taste, or color of the contents, and render it unacceptable. An example of a system for controlling the application of power to an induction coil for heating metal cans is disclosed in International Application No. PCT/US2015/026136, filed on Apr. 16, 2015, which is incorporated herein by reference in its entirety (including incorporation of all applications and documents incorporated into International Application No. PCT/US2015/026136).

Additionally, the system provides for the protection of the can body and end panels from damage caused by generation of excessive internal vapor/steam pressure in the can during processing/heating. Testing has shown that the pressure inside cans processed in an induction heating system may reach up to 100 psi during the heating process due to the generation of steam inside the can. Retort systems provide balancing pressure protection of the can body and ends by using steam to both heat and pressurize the outside of the can within the sealed processing retort. Thus, as the internal can contents temperature and pressure increases from MIH in the MIH sterilization processes, support for the outside of the can is provided by the present system to prevent permanent deformation/distortion of the can and/or rupturing of the can as a result of high internal pressures generated during MIH.

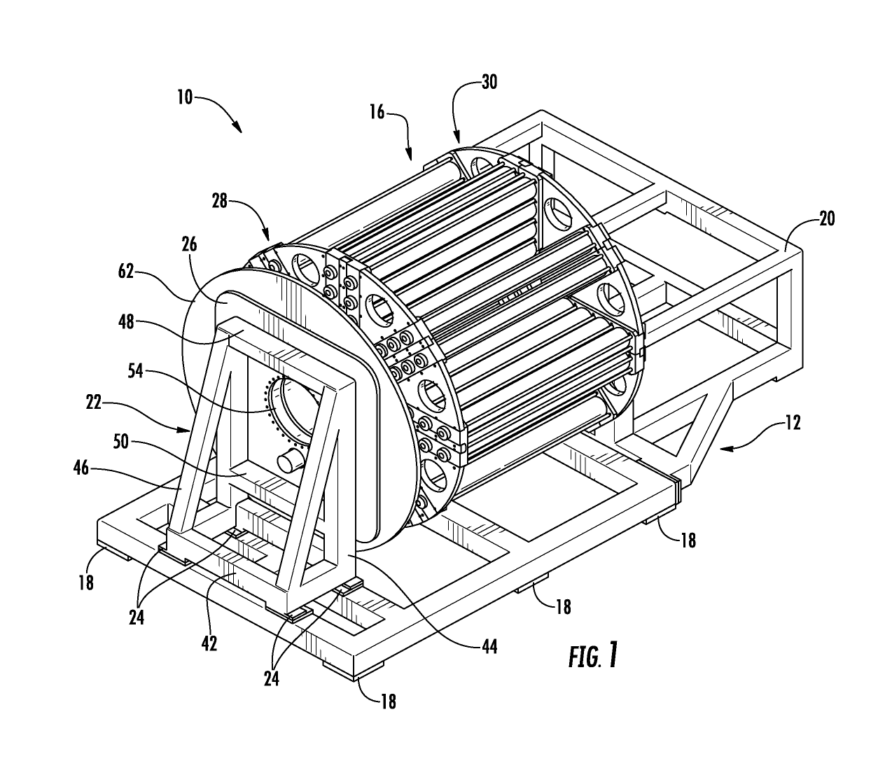

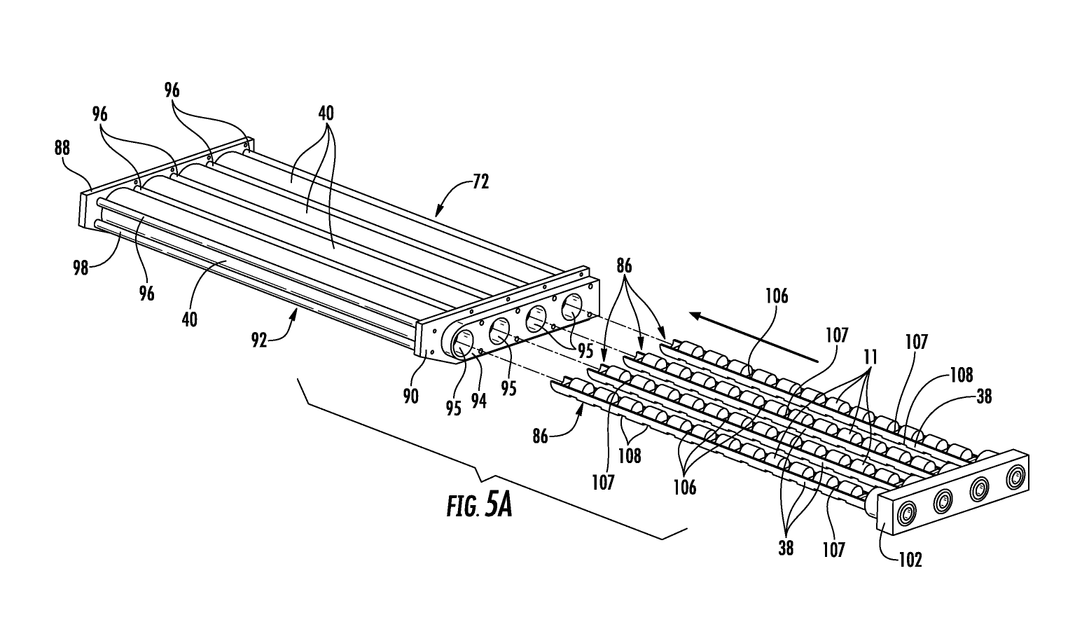

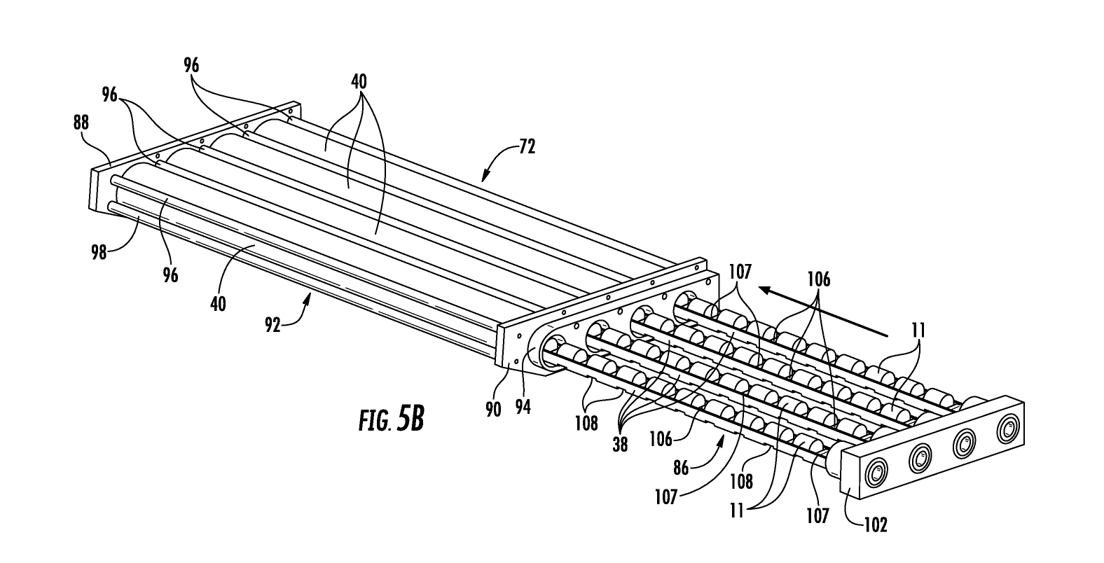

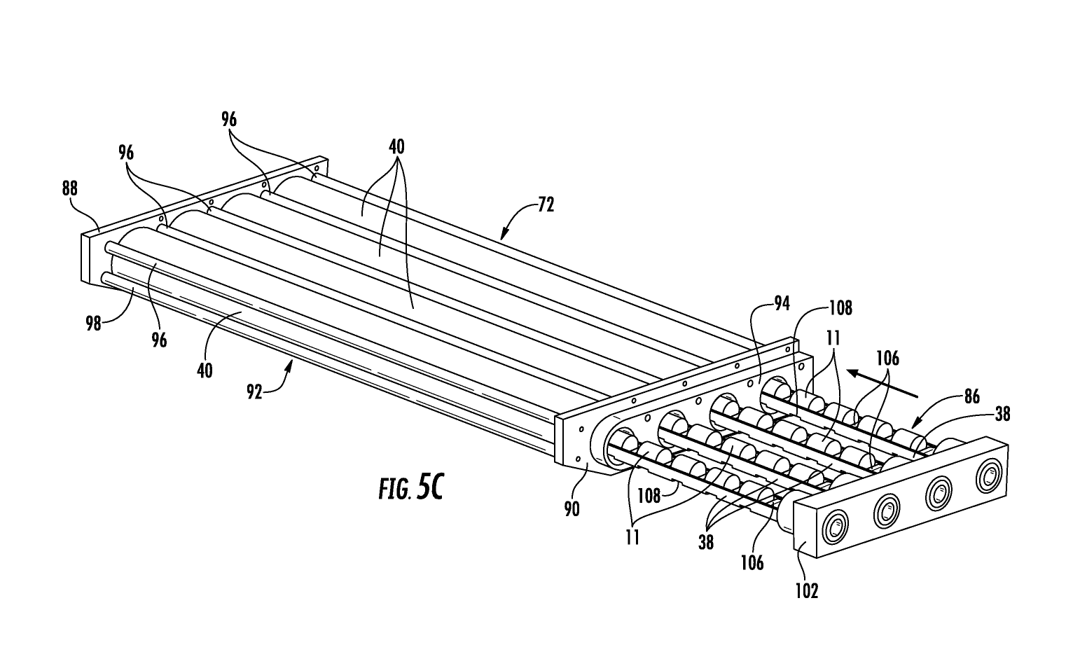

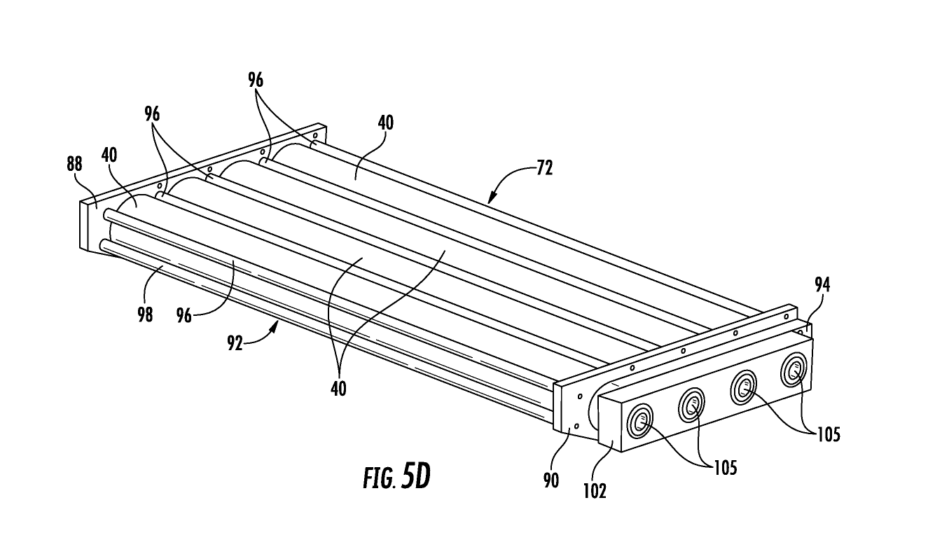

Referring to FIG. 1, an induction heating system 10 is shown for heating batches of sealed, ferrous metal cans 11 (see FIGS. 5A-5D). A plurality of metal cans 11 are loaded and unloaded into the induction heating system 10 that are filled with a food product (e.g., soup, vegetables, fruits, noodles, etc.) The induction heating system 10 includes a support frame 12, a distribution plate 62 and an indexing drum 16. The support frame 12 is entirely, or in part, fabricated from metal, e.g., steel, and includes a plurality of footings 18 on the bottom of the support frame 12. The footings 18 are used to provide a stable support for the support frame 12 relative to a factory floor to keep the induction heating system 10 stationary during operational and non-operational periods. In alternative embodiments, the footings 18 may include resilient support pads that may allow the support frame 12 and the induction heating system 10 to be moved from one location to another location within a factory or processing plant. Additionally, in alternative embodiments, the support frame 12 may include a plurality of wheels that further include a type of braking system that permits a user or a machine to move the induction heating system 10 from one location to another location with more ease. Once the induction heating system 10 is placed in its desired location, then the user may apply the brakes on the wheels to prohibit the support frame 12 and the induction heating system 10 from moving involuntarily.

Referring to FIG. 1, the support frame 12 further includes an extension frame 20 and a mounting frame 22. The extension frame 20 and mounting frame 22 may be fabricated entirely, or in part of metal, e.g., steel. The extension frame 20 is welded to and extends horizontally from the support frame 12. The extension frame 20 supports a transfer device such as a magnetic or vacuum gantry robot (not shown) that includes hardware and devices required for loading metal cans 11 into the induction heating system 10 and for unloading processed metal cans 11 from the induction heating system 10. The mounting frame 22 is located near the front and on top of the support frame 12. The mounting frame 22 includes a plurality of mounts 24 and a mounting plate 26. The mounts 24 are located between the bottom of the mounting frame 22 and the top of the support frame 12. The mounts 24 assist with attaching the mounting frame 22 to the support frame 12. The mounting plate 26 is substantially square in shape with rounded corners and is preferably welded to the mounting frame 22. Depending upon the application, the mounting plate 26 may be bolted to the mounting frame 22.

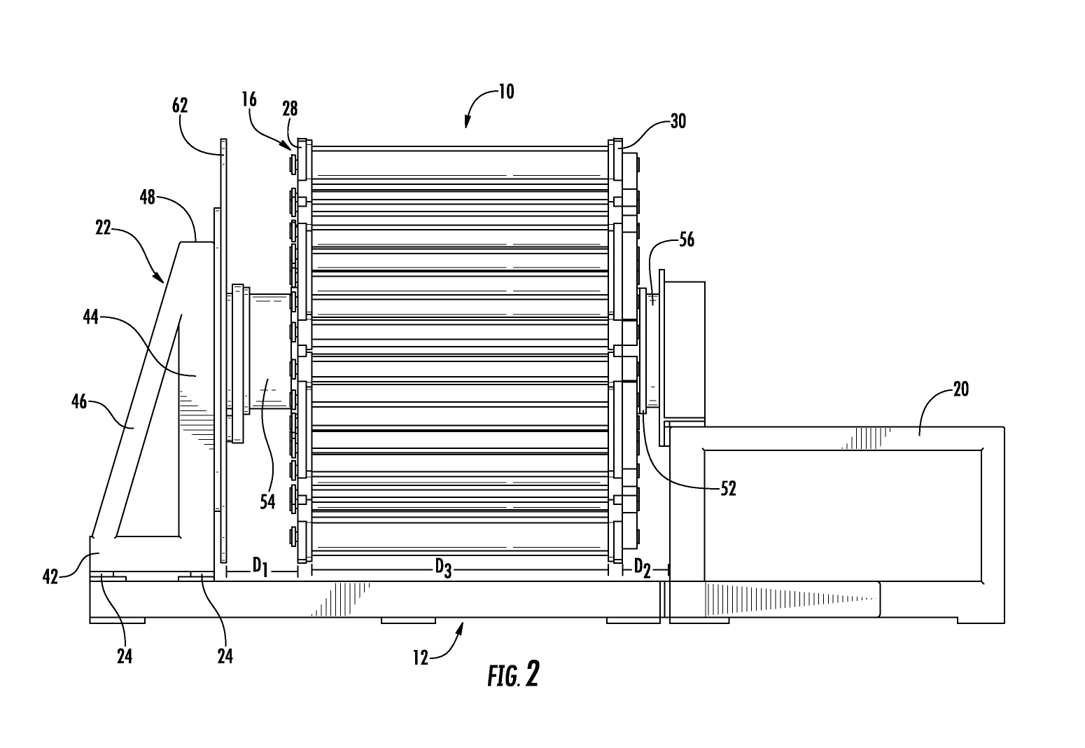

Referring to FIG. 1 and FIG. 2, the mounting frame 22 further includes a base 42, a pair of mounting plate supports 44, a pair of angular supports 46, a top 48 and a support beam 50. The base 42 is adjacent to the mounts 24 and is generally rectangular in shape. In the exemplary embodiment the portions of the base 42 form a rectangular perimeter, similar to a picture frame. In alternative embodiments, the portions of the base 42 may frame the perimeter of different shapes, e.g., square, trapezoid, circle, etc. or the base 42 may be not be a frame structure, but may include material that extends the entire length, width and/or height of the portions of the base 42. The pair of mounting plate supports 44 extends upwards from opposing ends of the top of the base 42. The pair of angular supports 46 extends from opposing sides of the base portion 42, opposite of the mounting plate supports 44, upwards to the top 48. The pair of angular supports 46 extend from the base 42 at an angle such that the distance between the pair of angular supports 46 and the pair of mounting plate supports 44 decreases as the pair of angular supports 46 and the pair of mounting plate supports 44 extend upwards towards the top 48. The top 48 is adjacent to the pair of mounting plate supports 44 and the pair of angular supports 46. The top 48 extends the length between the pair of mounting plate supports 44 and the length between the pair of angular supports 46. In the exemplary embodiment, the top 48 is substantially the same length as the base 42. In alternative embodiments, the top 48 may have a length that is shorter or longer than the base 42. The support beam 50 extends between the pair of mounting plate supports 44. The support beam 50 is located between the top 48 and the base 42. In the exemplary embodiment, the distance between the top 48 and the support beam 50 is greater than the distance between the base 42 and the support beam 50. In alternative embodiments, the distance between the top 48 and the support beam may be substantially the same as or less than the distance between the base 42 and the support beam 50.

Referring to FIG. 1, the distribution plate 62 includes a circular opening, a control system (not shown) for controlling the utilities (e.g., water, pressure, air, electrical, etc.) used during operation of the induction heating system 10, and controls for controlling the transfer device (not shown). The distribution plate 62 is stationary and is generally circular in shape and is adjacent to the mounting plate 26. In the exemplary embodiment, the distribution plate 62 has a diameter that is greater than the height and width of the mounting plate 26. In the exemplary embodiment, the distribution plate 62 is fabricated entirely, or in part, of metal, e.g., steel, and is welded to the mounting plate 26. In alternative embodiments, the distribution plate 62 may be composed of or fabricated from different materials than the mounting plate 26 and other components of the mounting frame 22, support frame 12 and extension frame 20. In alternative embodiments, the distribution plate 62 may be a different shape and may rotate. For example, the distribution plate 62 may be generally square, oval, or polygonal in shape. The distribution plate 62 provides rotational support for one end of the indexing drum 16 and also supports a bearing/drive unit 54 (e.g. an electric or hydraulic motor) which rotates the indexing drum 16 during operation.

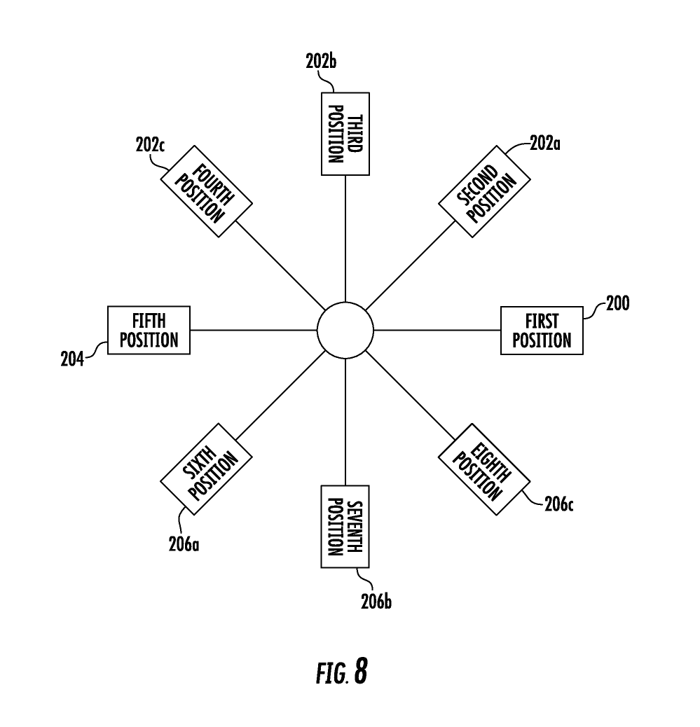

Referring to FIG. 1, the indexing drum 16 is fabricated entirely, or in part of metal, e.g., steel, and is located between the extension frame 20 and the mounting frame 22 and above the support frame 12. As with all components of the system the steel may be stainless steel where the corrosion resistance is important and stainless steel satisfies the structural requirements for a particular component. The indexing drum 16 includes a front plate 28 and rear plate 30 and is rotatable about a rotational axis. During operational periods, the indexing drum 16 rotates between a plurality of locations (see FIG. 8) around the rotational axis, including a loading/unloading station 200, a plurality of heating stations 202, a stabilizing station 204 and a plurality cooling stations 206 (see FIG. 8). In some embodiments, the indexing drum 16 may only rotate in the clockwise direction. In alternative embodiments, the indexing drum 16 may rotate in the counter-clockwise direction around the rotational axis or the indexing drum 16 may be able to rotate in both the clockwise and the counter-clockwise directions about the rotational axis.

Referring to FIG. 2, the induction heating system 10 further includes the bearing/drive unit 54 and a rear bearing 56. The indexing drum 16 is rotationally supported by the rear bearing 56 and rotated by the bearing/drive unit 54. A bearing support 52 and the rear plate 30 are configured to receive a portion of the rear bearing 56. A portion of the front plate 28 and a portion of the distribution plate 62 are configured to support the bearing/drive unit 54. The rear bearing 56 is mounted to support spacer tubes that are located on the bearing support 52. The bearing/drive unit 54 includes a motor such as, but not limited to, a high torque servo gear motor. The motor of the bearing/drive unit 54 is configured to very accurately index or rotate the indexing drum 16 through a selected angle and then stop or dwell the indexing drum 16. In the exemplary embodiment, the motor of the bearing/drive unit 54 is configured to control the indexing drum 16 to stop, start and rotate approximately 45° repetitiously about the horizontal axis. In full operational mode, the indexing drum 16 is rotated by control of the bearing/drive unit 54 through a 45° angle in approximately 4 seconds, after which the indexing drum 16 is stopped (i.e., not rotating) for a dwell cycle lasting approximately 30 seconds. The total cycle time per an index plus dwell cycle to process one batch of metal cans 11 is approximately 34 seconds. Given this timing, the total cycle time for one batch of 96 cans (in the exemplary embodiment there are 12 metal cans 11 per pressure chamber 40 with 4 chambers in each support arrangement 72 and 2 support arrangements 72 inserted into each pair of slot openings 66) is 272 seconds. However, after the system is running at steady state, the system outputs 96 cans every 34 seconds or about 180 cans per minute.

Referring to FIG. 2, the indexing drum 16 is supported by rear bearing 56 such that the bottommost edges of the front plate 28 and the rear plate 30 are spaced apart from the top of the support frame 12, permitting the indexing drum 16 to rotate smoothly during operational periods. The indexing drum 16 is separated from the distribution plate 62 by a distance of D1. The distance D1 is the length between the distribution plate 62 and the exterior surface of the front plate 28. The indexing drum 16 is separated from the extension frame 20 by a distance of D2. In the exemplary embodiment, the distance D1 is greater than D2. The length between the interior surface of the front plate 28 and the interior surface of the rear plate 30 is defined by a distance D3. The length of the pressure chambers 40 is substantially the same as the distance of the distance D3 of the indexing drum 16.

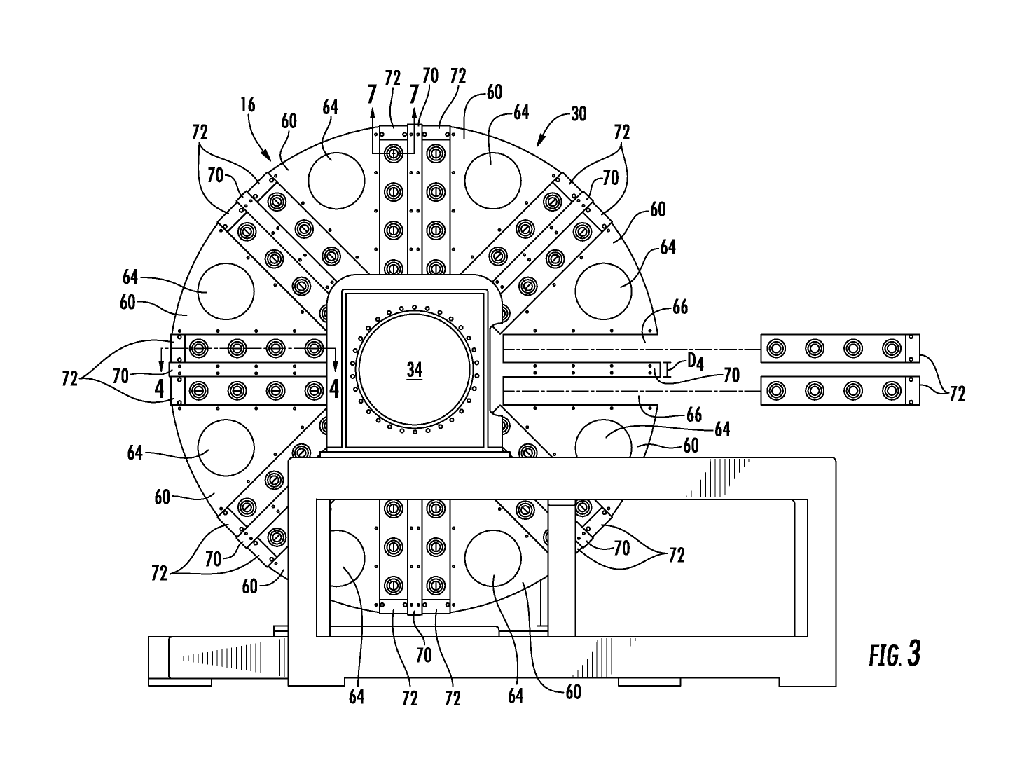

As shown in FIG. 3, the rear plate 30 is substantially circular in shape and includes a plurality of slot openings 66 and a bearing opening 34. The structure of the front plate 28 substantially mirrors the structure of the rear plate 30.

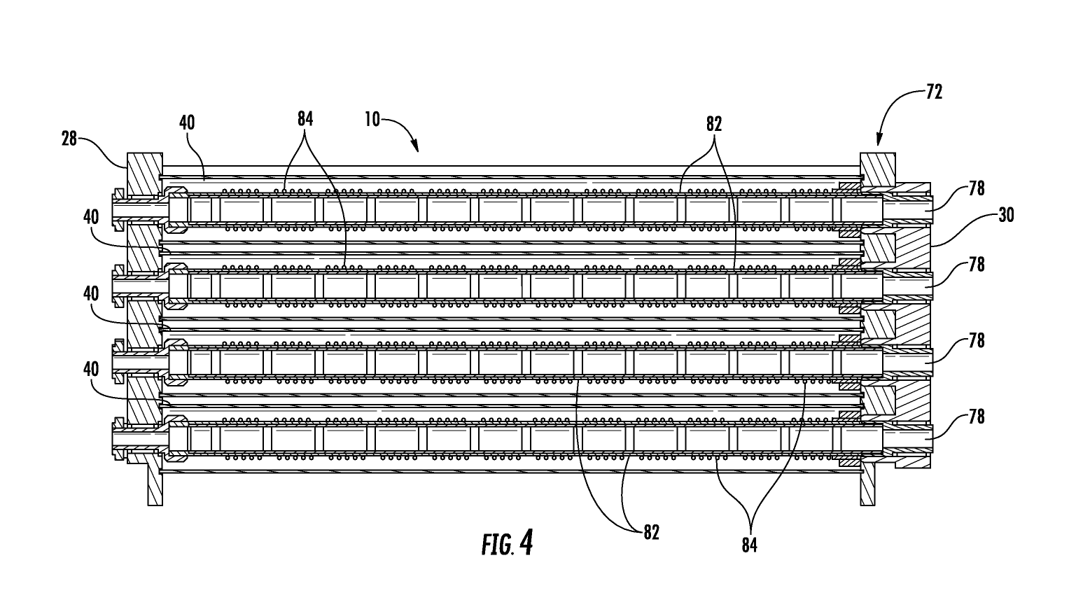

Referring to FIG. 3, the indexing drum 16 is configured to support a plurality of support arrangements 72. Each support arrangement 72 may be removed and inserted into and from the slot openings 66. Each of the support arrangements 72 is configured to house a plurality of pressure chambers 40 (see FIG. 4). In the exemplary embodiment, each support arrangement 72 is configured to support 4 pressure chambers 40. In alternative embodiments, the support arrangements 72 may hold a different amount of pressure chambers 40. For example, alternative embodiments may have more than or less than four pressure chambers 40 per support arrangement 72.

Referring to FIG. 3, the rear plate 30 includes a plurality of triangular sections 60. Each triangular section 60 includes a circular hollow portion 64 to reduce the weight of the rear plate 30. In the exemplary embodiment, the circular hollow portions 64 have the same dimensions as each other and are located near the outer periphery of the rear plate 30. Each triangular section 60 is separated by the slot openings 66 and a slot section 70. The slot openings 66 and slot sections 70 extend radially inwards from the outer periphery of the rear plate 30 towards the bearing support 52. Each slot opening 66 is configured to receive the support arrangement 72 in a parallel, spaced, side-by-side orientation. When inserted into slot opening 66, the support arrangement 72 extends from the rear plate 30 to the front plate 28. The support arrangement 72 has end portions that extend beyond the exterior surfaces of both the front plate 28 and the rear plate 30. Each pair of slot openings 66 is parallel with each other and separated by a distance D4. The distance D4 is the width of the slot section 70. Each adjacent pair of slot openings 66 is separated by triangular sections 60. The pairs of slot openings 66, the triangular sections 60 and the slot sections 70 are generally equally spaced about the rear plate 30 such that the top portion of the rear plate 30 is a mirror image of the bottom portion of the rear plate 30 and the left side portion of the rear plate 30 is a mirror image of the right side portion of the rear plate 30 at any given rotational position about the rotational axis. The arrangement of the pairs of slot openings 66, triangular sections 60 and slot sections 70 about the rear plate 30 is also a mirror image of the arrangement of the pairs of slot openings 66, triangular sections 60 and slot sections 70 about the front plate 28.

Referring to FIG. 3, in the exemplary embodiment, there are 8 pairs of slot openings 66 that are configured to receive 8 pairs of support arrangements 72. Each pair of slot openings 66 is spaced approximately 45° from an adjacent pair of slot openings 66. In alternative embodiments, the front plate 28 and the rear plate 30 may include slot openings 66 that are grouped together in more than groups of two slot openings 66, e.g., 3, 4, 5, etc., or there may only be one slot opening 66 in between two adjacent triangular sections 60. In alternative embodiments, the pairs of slot openings 66 may be separated by more than or less than 45°. For example, an alternative embodiment may have slot openings 66 grouped together every 90°. In alternative embodiments, the top portion of the rear plate 30 at any rotational position may not be a mirror image of the bottom portion of the rear plate 30. In alternative embodiments, the left side portion of the rear plate 30 at any rotational position may not be a mirror image of the right side portion of the rear plate 30.

Referring to FIG. 3, inserted into the indexing drum 16 are 8 pairs of support arrangements 72 that are spaced apart in a parallel, side-by-side orientation. The 8 pairs of support arrangements 72 are equally spaced apart from each other at approximately 45°. The number, spacing and arrangement of the pairs of support arrangement 72 correspond to the number, spacing, and arrangement of the pairs of slot openings 66. With this arrangement each pair of support arrangements 72 can be subject to a different stage of the MIH process as applied at each station (discussed below).

Referring to FIG. 4, a cross-sectional view of the support arrangement 72 is shown. The support arrangement 72 includes 4 pressure chambers 40 extending between the front plate 28 and the rear plate 30. The pressure chambers 40 of the induction heating system 10 each have an opening 78 that extends along the length of the pressure chamber 40 and permits access to the interior of each pressure chamber 40.

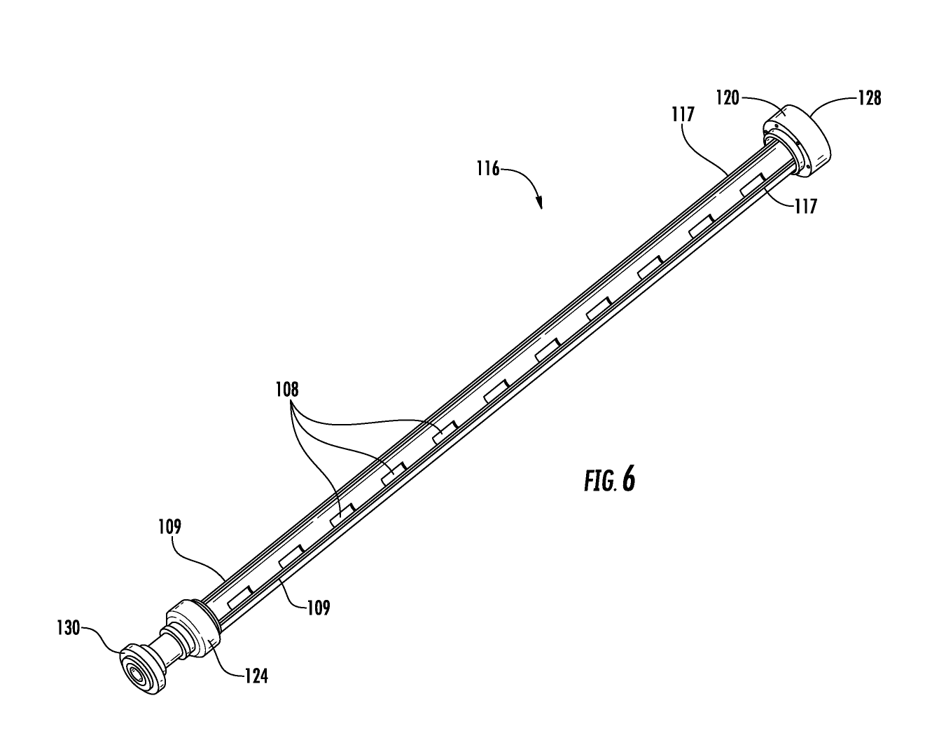

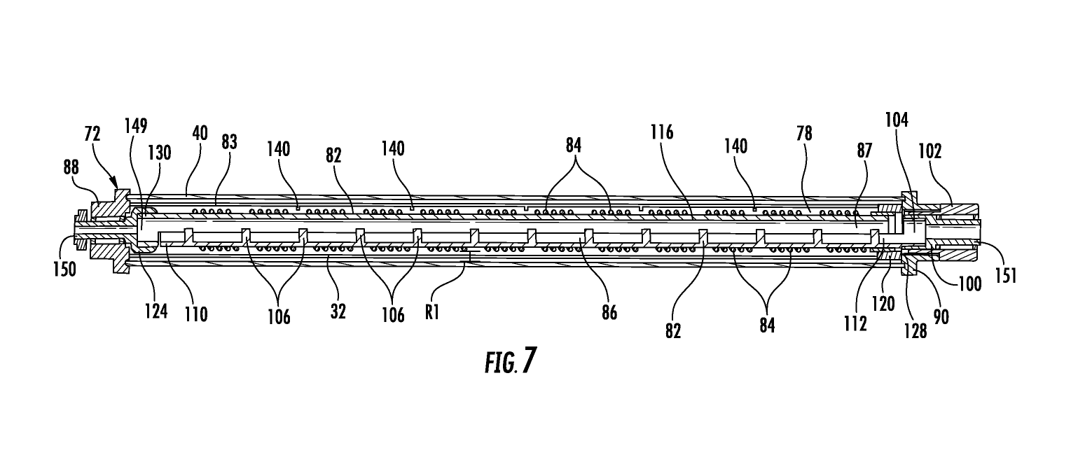

Referring to FIGS. 5A-5D, the steps of loading metal cans 11 into a support arrangement 72 is shown. For simplicity, in FIGS. 5A-5D the support arrangement 72 is shown as being freestanding. It should be understood however, that in operation, the support arrangement 72 would be positioned within the slot opening 66 in the indexing drum 16, and the metal cans 11 would be loaded into the support arrangement 72 while the support arrangement 72 remained mounted to the indexing drum 16. Each support half-tube 86 remain attached to a rotational support 151 (see FIG. 7) both inside and outside of the pressure chambers 40. When support half-tubes 86, and the metal cans 11 supported thereon, are fully inserted into pressure chambers 40, and each of the support half-tubes 86 are engaged with a half-tube 116 (see FIG. 6), rotation by a tube drive 150 of half-tube 116 is imparted to support half-tube 86.

Referring to FIGS. 5A-5D, each of the support arrangements 72 include an end plate 88, a front plate 90, a plurality of tension rod pairs 92 and an insert 94. The insert 94 is mounted to the front plate 90 by a series of fastening devices, e.g., nuts and bolts, screws or another type of fastening arrangement. The insert 94 may also be attached to the front plate 90 by other methods, e.g., welding. The insert 94 and the front plate 90 both include a series of insert openings 95. In the exemplary embodiment, the insert 94 and front plate 90 include 4 insert openings 95. The openings 78 and the insert openings 95 of the front plate 90 align with each other such that the support half-tubes 86 may be fully inserted into the pressure chambers 40. The tension rods 92 are configured to hold end plate 88 and front plate 90 in place when the pressurized chambers 40 are closed and pressurized during heating of the metal cans 11.

Referring to FIGS. 5A-5D, each pair of tension rods 92 has a top support rod 96 and a bottom support rod 98. The top support rod 96 is vertically displaced or horizontally displaced from the bottom support rod 98 depending upon the positioning of the support arrangement 72 within the indexing drum 16. Each set of tension rods 92 is adjacent to at least one pressure chamber 40. The center of one of the top tension rods 96 is located approximately 180° from the center of one of the other top tension rods 96 in a different pair of tension rods 92. The center of one of the bottom tension rods 98 is located approximately 180° from the center of one of the other bottom tension rods 98 in a different pair of tension rods 92. In alternative embodiments, there may be only one tension rod 92, or a set may include 3 or more tension rods 92 on at least two locations of the pressure chambers 40 that are located more or less than 180° from each other.

Referring to FIGS. 5A-5D, the support half-tubes 86 each include a tray 38, a bearing support 100 and a bearing 104 (see FIG. 7) and the support half-tubes 86 are supported by a sealing plate 102. During metal can 11 loading, support half-tubes 86 operate to support and arrange metal cans 11 before insertion to the respective pressure chambers 40. Each support half-tube 86 includes a plurality of dividers 106 and a plurality of perforations 108. The dividers 106 may be composed of the same material as the support half-tube 86. The support half-tubes 86 are loaded with metal cans 11 spaced by dividers 106. The dividers 106 prevent two adjacent metal can 11 ends from having direct contact with each other. The dividers 106 are generally semi-circular in shape. The curved portion of the dividers 106 is configured to conform with the bottom curved portion of the tray 38 and the flat portion of the dividers 106 extends between the two opposing sides of the tray 38. The dividers 106 are evenly spaced apart from each other the entire length of the tray 38. The distance between each divider 106 is slightly greater than the length of one of the metal cans 11.

Referring to FIGS. 5A-5D, the sealing plate 102 abuts with the insert 94 of the support arrangement 72 in the second position in which the support half-tubes 86 have been slid into the pressure chambers 40. The bearing supports 100 and the bearings 104 are provided in the sealing plate 102 to support the support half-tubes 86 in the pressure chambers 40 during operational and non-operational periods of the induction heating system 10. The sealing plate 102 further includes a plurality of sealing devices 105. The sealing devices 105 are configured to seal the pressure chambers 40 when support half-tubes 86 are within the pressure chamber 40. The support half-tubes 86 and the metal cans 11 supported in the support half-tubes 86 may be removed from the pressure chambers 40 when the sealing devices 105 are removed from the pressure chambers 40. The metal cans 11 may be removed from the support half-tubes 86 by the transfer device (not shown) when the support half-tubes 86 are removed from the pressure chambers 40. The sealing devices 105 may be removed from the pressure chambers 40 electrically, mechanically or manually.

Referring to FIG. 6, the half-tube 116 is shown disassembled and removed from the pressure chamber 40. Half-tube 116 is substantially the same length as the support half-tubes 86. As discussed above, the half-tube 116 is slidably engageable with support half-tube 86 to form a closed, perforated holding tube 87 into which sealed, metal cans 11 are loaded at the loading station. Each pressure chamber 40 included in the induction heating system 10 has one half-tube 116 rotatably supported within the pressure chamber 40. The half-tube 116 has a collar end 128, a drive end 130, a collar 120, plurality of perforations 108 and a rotator 124. The half-tube 116 is generally semi-circular in shape with a pair of edges 117 along which engagement elements 109 are positioned.

Referring to FIG. 6 and FIG. 7, the perforations 108 allow water to pass through the support half-tube 86 and half-tube 116. The perforations 108 are located between two dividers 106 on support half-tube 86. The perforations 108 are generally rectangular in shape and extend only a portion of the length of the metal can 11. In alternative embodiments, the perforations may be different shapes and sizes, e.g., circular, oval or a series of smaller squares, etc.

Referring to FIG. 6 and FIG. 7, when support half-tubes 86 are slid into pressure chambers 40, engagement elements 107 (see FIGS. 5A-5D) located on the support half-tubes 86, (e.g. a pair of channels extending along the edges of support half-tube 86 along the length of the support half-tube 86) are configured to mate with a corresponding engagement element 109 extending along the edges of the half-tube 116 along the length of the half-tube 116 (e.g. a tongue portion configured to be slid into the channels of the support half-tube 86, etc.). The interaction and coupling of engagement elements 107 and 109 is configured to removably join together support half-tubes 86 and half-tubes 116 to form full holding tubes 87.

Referring to FIG. 7, a holding tube 87 and an induction coil 82 are located within the opening 78 of each pressure chamber 40. Each holding tube 87 includes a non-ferrous support half-tube 86, a non-ferrous half-tube 116. Connected to each holding tube 87 are a drive interface 149 and the rotational support (e.g. a bearing) 151. Support half-tube 86 is configured to receive metal cans 11 from the transfer device and hold the plurality of metal cans 11 (e.g., 12 metal cans) in an end-to-end relationship with the divider 106 located between 2 adjacent metal cans 11. The induction coil 82 is supported within the pressure chamber 40 such that the induction coil 82 is arranged adjacent to and concentrically surrounding the exterior of the holding tube 87. During loading and unloading of the metal cans 11 into the pressure chambers 40 located in the support arrangement 72, half-tubes 116 remain within respective pressure chambers 40 and remain engaged with respective tube drives 150.

Referring to FIG. 7, a cross-section of one of the pressure chambers 40 with the holding tube 87 fully assembled is shown. The support arrangement 72 further includes a power supply input (not shown). The power supply input couples the power source to the induction coil 82 to energize the induction coil 82 and a plurality of coil segments 84 to generate alternating current to induce current into the metal cans 11 that are supported within the pressure chambers 40 in the holding tubes 87. The current induced into the metal cans 11 heats the content of the metal cans. The frequency and voltage of the alternating current used to energize the induction coil 82 to induce the current into the metal cans 11 to heat the contents of the metal cans 11 may be varied to optimize the heating process based upon the can shape, size, contents and desired heating profile of the metal cans 11.

Referring to FIG. 7, each drive interface 149 engages with a respective tube drive 150 when the holding tube 87 is inserted into a pressure chamber 40. Upon insertion, the rotational support 151 is supported by the pressure chamber 40 at the end opposite the tube drive 150. Each tube drive 150 rotates a holding tube 87 during energization of the induction coil 82. The tube drive 150 may rotate the holding tube 87 about its longitudinal axis in both or either the clockwise and counter-clockwise directions at speeds between 240 rpm-260 rpm, more specifically at 250 rpm. In alternative embodiments, depending upon the contents of the metal cans 11 held in the holding tubes 87, the tube drives 150 may also be controlled to oscillate the holding tubes 87 at a specific frequency selected for the particular contents.

Referring to FIG. 7, the induction coil 82 is divided into coil segments 84 that are arranged linearly adjacent to each other and that extend the majority of the length of the pressure chambers 40. The coil segments 84 are generally helical in shape and each coil segment 84 extends approximately the length of one metal can 11 and is located over the axial midpoint of each of the metal cans 11.

Referring to FIG. 7, each of the support half-tubes 86 has an engagement end 110 and a bearing end 112. The engagement ends 110 are free and unattached, and are configured to be inserted into the respective openings 78 of each pressure chamber 40. The bearing ends 112 are inserted into the respective bearing supports 100 near the sealing plate 102.

Referring to FIG. 7, in addition to the power supply input, connected to the pressure chambers 40 are also: an air pressure input, a cooling channel input, and a water source input (all not shown). The air pressure input couples an air pressure to the pressure chambers 40 to pressurize the pressure chambers 40 during energization of the induction coil 82 and the coil segments 84. The cooling channel input connects a water source to an opening (not shown) in the end plate 88. A cooling channel 83 is connected to the cooling channel input and extends within the pressure chambers 40 from the end plate 88 to the interior side of the front plate 90. The cooling channel 83 is located between the periphery of the pressure chambers 40 and the induction coil 82 and coil segments 84. The cooling channel 83 has a plurality of nozzles 140 located within the pressure chambers 40. The water source is coupled to the nozzles 140 to cool the metal cans 11 located within the holding tubes 87 in the pressure chambers 40. The water source dispenses water through the cooling channel 83 and through the nozzles 140. During operation of the heating induction system 10, the cooling water is released from the nozzles 140 down onto the induction coil 82 and the coil segments 84 to cool the coils down in temperature. The helical shape of the coil segments 84 allows water to pass through the gaps of the coil segments 84 that are created by the coil segments 84 being helically wrapped around the holding tubes 87. The water then flows down and through the perforations 108 of the holding tube 87, cools down the metal cans 11 and then proceeds to flow out of the holding tube 87 through the perforations 108. The water is then removed from the pressure chambers 40 by a removal channel 32. The water enters the removal channel 32 and is removed via an outlet located on the exterior of the support arrangement 72 and taken to a holding tank (not shown). The water in the holding tank is then cooled back down to a specific temperature range to be reused again in the cooling process of the metal cans 11, the induction coil 82 and the coil segments 84. The water may be transferred to the holding tank by using a pump or a vacuum method.

Referring to FIG. 7, in operation, the power supply, air pressure source and cooling water source (all not shown) are controlled so that the metal cans 11 are properly heated and cooled while the respective pressure chambers 40 are pressurized so that metal cans 11 do not burst or permanently deform during heating and are not collapsed due to too much pressure during cooling. Accordingly, air pressure source is controlled to cycle from atmospheric pressure at the start of heating and return to atmospheric pressure when the cans are sufficiently cooled to remove from the pressure chambers 40.

Referring to FIG. 7, the purpose of the dividers 106 in support half-tubes 86 is to position the metal cans 11 such that when the holding tubes 87 are fully assembled in the pressure chambers 40, the metal cans 11 are properly aligned with coil segments 84. The amount of coil segments 84 in the pressure chamber 40 and the number of metal cans 11 housed in the can holding tubes 87 are in a 1:1 ratio. The coil segments 84 are configured to heat one or more metal cans 11 located adjacent to the coil segment 84. In the exemplary embodiment, there are 12 metal cans 11 loaded onto each support half-tube 86 that are inserted into a pressure chamber 40, and there are 12 coil segments 84 supported within the pressure chambers 40, resulting in one coil segment 84 per metal can 11. In alternative embodiments, the induction coil 82 may have more or less coil segments 84 compared to the amount of metal cans 11. For example, an alternative embodiment may include an induction coil 82 having 8 coil segments 84 while 16 metal cans 11 are located in the holding tube 87. In other alternative embodiments the induction coil 82 may comprise a single, non-segmented coil. In yet other alternative embodiments, the coil segments 84 may not be helical. For example, the induction coil 82 may have coil segments 84 that linearly extend along the length of the pressure chamber 40 or coil segments 84 that are sigmoidal in shape to increase the surface area of the induction coil 82 near the metal cans 11, therefore increasing the heating efficiency of the metal cans 11.

Referring to FIG. 7, the collar 120 is generally circular in shape with a hollow portion. The collar 120 is adjacent to the interior side of the front plate 90 and is fastened to the front plate 90 to remain stationary with a fastening arrangement, e.g., nuts and bolts, screws, welding, etc. The hollow portion is configured to receive both a portion of the support half-tube 86 near the bearing end 112 and a portion of the half-tube tube 116 near the collar end 128. The perforations 108 of the support half-tubes 86 and the half-tubes 116 are mirror images of each other. Each perforation 108 in the half-tubes 116 are generally rectangular in shape and align with the perforations 108 of the support half-tube 86. In alternative embodiments, the perforations 108 may be different shapes and sizes, such as circular, oval or a series of smaller squares, etc. In alternative embodiments, the perforations 108 in the half-tubes 116 may be different sizes and shapes from the perforations 108 of the support half-tubes 86.

Referring to FIG. 7, the rotator 124 is attached to the drive end 130 of the half-tubes 116 via a jaw clutch or spline arrangement. The rotator 124 is connected to a drive head (not shown) that controls the rotator 124 to rotate both in clockwise and counter-clockwise directions about the horizontal axis. Any rotation applied to the rotator 124 causes the half-tubes 116 and the support half tubes 86 to move in the same direction and at the same rate. Depending upon the contents and/or shape of the metal cans 11, the rotator 124 may also provide a pulsing motion, allowing the half-tubes 116 and support half-tubes 86 to pulse and move in a linear direction, parallel to the horizontal axis, in addition to imparting rotational motion that rotates the holding tube 87 about the horizontal axis.

Referring to FIG. 7, the pressure chambers 40 include a thermal sensor (not shown). The thermal sensor measures the temperature of the metal cans 11 located at the drive end 130 of the holding tubes 87 and the collar end 128 of the holding tubes 87. The thermal sensors are high thermal conductivity discs that are spring loaded against the ends of the metal can 11 nearest the drive end 130 and the metal can 11 nearest the collar end 128 in each pressure chamber 40.

Referring to FIG. 7, the pressure chambers 40 extend along a longitudinal axis. A radial distance R1 is defined as the distance between the interior surface of the pressure chambers 40 and the exterior surface of the induction coil segments 84. In the exemplary embodiment, the holding tubes 87 are supported within the pressure chambers 40 such that the holding tubes 87 and the pressure tubes 40 extend along the same longitudinal axis. The radial distance R1 is the same along the length of the pressure chambers 40. For example, the radial distance R1 between two points approximately 180° away from each other within the pressure chamber 40 may be the same. The holding tubes 87 are rotationally supported within the pressure chambers 40. The diameter of the pressure chambers 40 is selected to accommodate a desired metal can 11 size, the associated holding tube 87 and induction coil 82. Maintaining the diameter as small as possible for a given metal can 11 size reduces the energy consumed by the system due to applying pressure to the metal cans 11 during processing.

Referring to FIG. 8, a diagram of the various stages of the induction heating system 10 is shown. The loading/unloading station 200 is located at the first position. At the loading/unloading station 200 the transfer device that is controlled by a control system removes the tray 38 of the top half of the support arrangement 72 and the tray 38 of the bottom half of the support arrangement 72. The transfer device lifts 4 parallel rows (in an exemplary embodiment, each row including 12 metal cans 11) of closed, filled, unheated metal cans 11 from an infeed conveyor (not shown) and places the metal cans 11 in the empty support half-tubes 86 of the support arrangement 72. The transfer device inserts the tray 38 with 4 support half-tubes 86 that are fully loaded into the top support arrangement 72 containing 4 pressure chambers 40. The tray 38 being inserted into the top half of the support arrangement 72 exposes the tray 38 on the bottom half of the support arrangement. The infeed conveyor is quickly reloaded with additional metal cans 11 that are then lifted by the transfer device and placed into the empty support half-tubes 86 of the bottom half of the support arrangement 72. The transfer device inserts the tray 38 with the 4 support half-tubes 86 that are fully loaded into the bottom support arrangement 72 containing 4 pressure chambers 40. The sealing device 105 is applied to each of the pressure chambers in both trays 38 in the top half of the support arrangement 72 and the bottom half of the support arrangement 72 during operational periods of the induction heating system 10. When both support arrangements 72 are fully loaded the indexing drums 16 rotates approximately 45° in the counter-clockwise direction to the second position.

Referring to FIG. 8, the first heating station 202a is located at the second position and is approximately 30 seconds long. At the first heating station 202a the food product in the metal cans 11 is agitated by the holding tubes 87, being rotated in directions, speeds and frequencies as dictated by the particular can shape, size and content being processed. Tube drive 150 is powered and controlled to rotate the holding tubes 87. Power is supplied to the induction coil 82 and the coil segments 84, so as to induce heating in the adjacent metal cans 11 while the metal cans 11 are being rotated.

Referring to FIG. 8, at the first heating station 202a, air pressure is also gradually introduced into the pressure chambers 40 via the pressure source input. The pressure chambers 40 include pressure sensors (not shown) that provide feedback on the amount of pressure achieved in each of the pressure chambers 40. The air pressure gradually increases in the pressure chambers 40 to balance the steam pressure generated within each metal can 11 being heated and to prevent the metal cans 11 from bursting or permanently distorting.

Referring to FIG. 8, at the first heating station 202a, the holding tubes 87 are rotated, the pressure chambers 40 are being pressurized and the induction coils 82 and induction coil segments 84 are applying currents to induce heating of the metal cans 11. At the end of the 30 second cycle, an air pressure control valve (not shown) in the pressure chamber 40 closes, allowing the final air pressure in the first heating station 202a to be maintained during indexing of the index drum 16 to the third position. The holding tubes 87 stop rotating and the induction coils 82 and induction coil segments 84 stop heating at the end of the 30 second cycle of the first heating station 202a. The amount of current applied to the induction coil 82 and the induction coil segments 84 and the amount of pressure introduced into the pressure chambers 40 at the first heating station 202a is dependent upon the metal can size, type and contents.

Referring to FIG. 8, the second of the heating stations 202b is located at the third position and is approximately 30 seconds long. At the second heating station 202b in the agitation of the food product in the metal cans continues. Power is supplied to the induction coil 82 and the induction coil segments 84, thus the induction coil 82 and the induction coil segments 84 restart applying heat to the adjacent metal cans 11 while the metal cans 11 are being rotated. Thermal sensors are again applied at the second heating station 202b to measure the temperature of the metal cans 11 located at the drive end 130 of the holding tubes 87 and the collar end 128 of the holding tubes 87. Air pressure is also gradually introduced into the pressure chambers 40 at the second heating station 202b via the pressure source input. The pressure sensors provide feedback on the amount of pressure achieved in each of the pressure chambers 40 at the second heating station 202b. The air pressure gradually increases in the pressure chambers 40 to balance the steam pressure generated by each metal can 11 being heated and to prevent the metal cans 11 from distortion. At the second heating station 202b the holding tubes 87 are rotated, the pressure chambers 40 are being pressurized and the induction coils 82 and induction coil segments 84 are applying currents to heat up the metal cans 11 simultaneously with each other. At the end of the 30 second cycle, the air pressure control valve 156 closes, allowing the final air pressure in the second heating station 202b to be maintained during the transfer to the third heating station 202c at the fourth position of the index drum 16. The holding tubes 87 stop rotating and the induction coils 82 and induction coil segments 84 stop heating at the end of the 30 second cycle of the second heating station 202b. The amount of current applied to the induction coil 82 and the induction coil segments 84 and the amount of pressure introduced into the pressure chambers 40 at the second heating station 202b is dependent upon the metal can 11 size, type and contents.

Referring to FIG. 8, the third of the heating stations 202c is located at the fourth position and is approximately 30 seconds long. At the third heating station 202c the agitation of the food product in the metal cans 11 continues. Power is supplied to the induction coil 82 and the induction coil segments 84, thus the induction coil 82 and the induction coil segments 84 restart applying heat to the adjacent metal cans 11 while the metal cans 11 are being agitated. The thermal sensors are again applied at the third heating station 202c to measure the temperature of the metal cans 11 located at the drive end 130 of the holding tubes 87 and the collar end 128 of the holding tubes 87.

Referring to FIG. 8, air pressure is also gradually introduced into the pressure chambers 40 at the third heating station 202c via the pressure source input. The pressure sensors provide feedback on the amount of pressure achieved in each of the pressure chambers 40 at the third heating station 202c. The air pressure gradually increases in the pressure chambers 40 to balance the steam pressure generated by each metal can 11 being heated and to prevent the metal cans 11 from distortion. At the third heating station 202c, the holding tubes 87 are rotated, the pressure chambers 40 are being pressurized and the induction coils 82 and induction coil segments 84 are applying currents to heat up the metal cans 11 simultaneously with each other. At the end of the 30 second cycle, the air pressure control valve 156 closes, allowing the final air pressure in the third heating station 202c of the fourth position to be maintained during the transfer to the fifth position. The holding tubes 87 stop rotating and the induction coils 82 and induction coil segments 84 stop heating at the end of the 30 second cycle of the third heating station 202c. The amount of current applied to the induction coil 82 and the induction coil segments 84 and the amount of pressure introduced into the pressure chambers 40 at the third heating station 202c is dependent upon the metal can 11 size, type and contents.

Referring to FIG. 8, a stabilizing station 204 is located at the fifth position and is approximately 30 seconds long. At the stabilizing station 204 agitation of the metal cans 11 continues. Power is no longer being delivered to the induction coil 82 and the induction coil segments 84. The induction coil 82 and the induction coil segments 84 are no longer inducing heating in the adjacent metal cans 11. The thermal sensors 154 are again applied at the stabilizing station 204 to measure the temperature of the metal cans 11 located at the drive end 130 of the holding tubes 87 and the collar end 128 of the holding tubes 87. The temperature measurement at the stabilizing station 204 provides traceable proof that all the metal cans 11 located in the holding tubes 87 in the pressure chambers 40 achieve the desired level of sterilization. Air pressure is still gradually introduced into the pressure chambers 40 at the stabilizing station 204 via the pressure source input. The pressure sensors provide feedback on the amount of pressure achieved in each of the pressure chambers 40 at the stabilizing station 204. The air pressure may still gradually increases in the pressure chambers 40 during a portion of this cycle, but will eventually come to equilibrium pressure with the internal metal can 11 pressure to balance steam pressure generated by each metal can 11 being heated and to prevent the metal cans 11 from distortion. At the stabilizing station 204, the holding tubes 87 are rotated and the pressure chambers 40 are being pressurized simultaneously with each other. At the end of the 30 second cycle, the air pressure control valve closes, allowing the final air pressure in the stabilizing station 204 of the fifth station to be maintained during the transfer to the sixth position. The holding tubes 87 stop rotating at the end of the 30 second cycle of the stabilizing station 204. The amount of pressure introduced into the pressure chambers 40 at the stabilizing station 204 is dependent upon the metal can 11 size, type and contents.

Referring to FIG. 8, a first of the cooling stations 206a is located at the sixth position and is approximately 30 seconds long. At the first cooling station 206a of the sixth position the food product in the metal cans 11 is agitated. Cooling water is dispensed from the water source through the cooling channel 83 and continues through nozzles 140 and flows over and through the induction coils 82 and the coil segments 84 through the perforations 108 of the holding tube 87 and onto the metal cans 11. The passing cooling water begins to decrease the temperature of the induction coils 82, the coil segments 84 and the metal cans 11. After the cooling water passes over the metal cans 11, the cooling water exits through the perforations 108 of the can support tubes 86 and caught in the removal channel and exits the pressure chambers through a drain (not shown). The cooling water that passes through the drain is pumped back to a holding tank where the cooling water is brought to a specific temperature to be used once again in the cooling stations 206. Each of the drains includes a flow control valve (not shown). The flow control valves maintains the level of cooling water in the pressure tubes 40 between the upper and lower limits to assure that the drain is never fully uncovered which may cause rapid drop in internal pressure in the pressure chambers 40, which may possibly cause metal cans 11 to rupture or distort. Air pressure in the pressure chambers 40 is slowly and gradually vented through an air discharge system (not shown). The air discharge system is located above the level of the drain water. The pressure sensors 152 provide feedback on the gradual pressure reduction in each of the pressure chambers 40 in the first cooling station 206a. Slow air pressure reduction continues through the 30 second cycle to balance the steam pressure reduction occurring in of the each metal cans 11 due to the water cooling. Internal and external metal can pressures are kept in balance during the first cooling station 206a to prevent the metal cans 11 from distortion. At the first cooling station 206a, the holding tubes 87 are rotated, the pressure chambers 40 are being pressurized, the induction coils 82 and induction coil segments 84 are being cooled with cooling water and the metal cans 11 are being cooled with cooling water simultaneously with each other. At the end of the 30 second cycle, the air pressure control valve 156 closes and the flow control valve closes, allowing the final air pressure in the sixth station to be maintained during the transfer to the second cooling station 206b at the seventh position. The holding tubes 87 stop rotating and the cooling water is no longer flowing through the pressure chambers 40 at the end of the 30 second cycle of the first cooling station 206a position. The amount of pressure reduced from the pressure chambers 40 at the first cooling station 206a is dependent upon the metal can 11 size, type and contents.

Referring to FIG. 8, the second of the cooling stations 206b is located at the seventh position and is approximately 30 seconds long. At the second cooling station 206b in the seventh position the agitation of the food product in the metal cans 11 is continued. Cooling water is again dispensed from the water source through the cooling channel 83 and continues through nozzles 140 and flows over and through the induction coils 82 and the induction coil segments 84 through the perforations 108 of the holding tube 87 and onto the metal cans 11. The passing cooling water continues to decrease the temperature of the induction coils 82, the induction coil segments 84 and the metal cans 11. After the cooling water passes over the metal cans 11, the cooling water exits through the perforations 108 and caught in the removal channel and exits the pressure chambers through the drain. The cooling water that passes through the drain is pumped back to the holding tank where the cooling water is brought to a specific temperature to be used once again in the cooling stations 206. Each of the drains includes the flow control valve. The flow control valves maintains the level of cooling water in the pressure tubes 40 between the upper and lower limits to assure that the drain is never fully uncovered which may cause rapid drop in internal pressure in the pressure chambers 40, which may possibly cause metal cans 11 to rupture or distort. Air pressure in the pressure chambers 40 is slowly and gradually vented through the air discharge system. The air discharge system is located above the level of the drain water. The pressure sensors 152 provide feedback on the gradual pressure reduction in each of the pressure chambers 40 in the second cooling station 206b. Slow air pressure reduction continues through the 30 second cycle to balance the steam pressure reduction occurring in of the each metal cans 11 due to the water cooling. Internal and external metal can pressures are kept in balance during the second cooling station 206b to prevent the metal cans 11 from distortion. At the second cooling station 206b, the holding tubes 87 are rotated, the pressure chambers 40 are being pressurized, the induction coils 82 and induction coil segments 84 are being cooled with cooling water and the metal cans 11 are being cooled with cooling water simultaneously with each other. At the end of the 30 second cycle, the air pressure control valve 156 closes and the flow control valve closes, allowing the final air pressure in the second cooling station 206b to be maintained during the transfer to the eighth position. The holding tubes 87 stop rotating and the cooling water is no longer flowing through the pressure chambers 40 at the end of the 30 second cycle of the second cooling station 206b. The amount of pressure reduced from the pressure chambers 40 at the second cooling station 206b is dependent upon the metal can 11 size, type and contents.

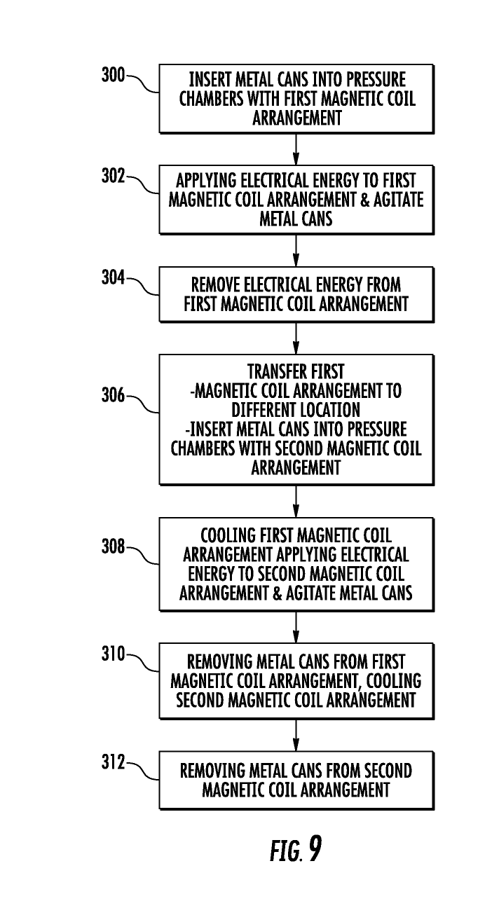

Referring to FIG. 9, the third of the cooling stations 206c is located at the eighth position and is approximately 30 seconds long. At the third cooling station 206c agitation of the cans is continued. Cooling water is again dispensed from the water source through the cooling channel 83 and continues through nozzles 140 and flows over and through the induction coils 82 and the induction coil segments 84 through the perforations 108 of the holding tube 87 and onto the metal cans 11. The cooling water continues to decrease the temperature of the induction coils 82, the induction coil segments 84 and the metal cans 11. After the cooling water passes over the metal cans 11, the cooling water exits through the perforations 108 of the can support tubes 86 and caught in the removal channel and exits the pressure chambers through the drain. The cooling water that passes through the drain is pumped back to a holding tank where the cooling water is brought to a specific temperature to be used once again in the cooling stations 206. Each of the drains includes the flow control valve. The flow control valves 160 maintains the level of cooling water in the pressure tubes 40 between the upper and lower limits to assure that the drain is never fully uncovered which may cause rapid drop in internal pressure in the pressure chambers 40, which may possibly cause metal cans 11 to rupture or distort. At the end of the 30 second cycle at the third cooling station 206c, the flow control valve is fully open to allow all of the remaining water to drain out of the pressure chambers 40 in preparation of opening at the first position, the loading/unloading station 200. Air pressure in the pressure chambers 40 is slowly and gradually vented through the air discharge system. The air discharge system is located above the level of the drain water. The pressure sensors 152 provide feedback on the gradual pressure reduction in each of the pressure chambers 40 in the third cooling station 206c. Slow air pressure reduction continues through the 30 second cycle to balance the steam pressure reduction occurring in of the each metal cans 11 due to the water cooling. Internal and external metal can pressures are kept in balance during the cooling station 206 to prevent the metal cans 11 from distortion. At the end of the 30 second cycle at the third cooling station 206c, the pressure chambers 40 have been vented back to atmospheric pressure in preparation for opening and unloading of the cans at the loading/unloading station 200 of the first position. At the third cooling station 206c, the holding tubes 87 are rotated, the pressure chambers 40 are being pressurized, the induction coils 82 and induction coil segments 84 are being cooled with cooling water and the metal cans 11 are being cooled with cooling water simultaneously with each other. At the end of the 30 second cycle, the air pressure control valve 156 closes and the flow control valve 160 opens, allowing the atmospheric pressure in the third cooling station 206c to be maintained during the transfer to the first position. The holding tubes 87 stop rotating and the cooling water is no longer flowing through the pressure chambers 40 at the end of the 30 second cycle of the eighth position. The amount of pressure reduced from the pressure chambers 40 at the third cooling station 206c brings the chamber to atmospheric pressure.

Referring to FIG. 8, after the third cooling station 206c, the processed, induction heated metal cans 11 return to the load/unload station 200 where they are removed from the chambers 40 and the transfer device removes the processed metal cans 11 from the tray 38 and places them on a discharge conveyor. Once the processed batch of metal cans 11 has been emptied by the transfer device, the transfer device then picks up and loads a new batch of unheated metal cans 11 from the infeed conveyor into the empty support half-tubes 86 of the top half of the support arrangement 72. The loaded cans 11 are processed as described above.

Referring to FIG. 8, by way of example, one heating station 202 may be controlled to the heat metal cans 11 for approximately 30 to 90 seconds to bring the contents to approximately 280-290° F. while rotating the metal cans 11 at up to 250 rpm. The air pressure in the pressure chamber 40 is increased during heating to provide overpressure to resist can deformation and rupturing. To terminate heating, the power to the induction coil 82 and induction coil segments 84 is shut off, and the metal cans 11 are allowed to stabilize while still rotating for approximately 15 to 30 seconds with no additional heating from the induction coil 82 and induction coil segments 84. After stabilizing, and with the induction coil 82 and induction coil segments 84 off, cooling water is flooded over the metal cans 11 thru the induction coil 82 and induction coil segments 84 as the metal cans 11 continued to rotate. Depending on the metal can 11 size and content, cooling with chilled water typically takes 30 to 90 seconds to bring the temperature and pressure in the metal can 11 down to a level (e.g. below 210° F.) which will not permanently deform or rupture the metal cans 11 upon removal of the overpressure. While the metal cans 11 are cooled, the pressure in the pressure chambers 40 is decreased to prevent crushing of the metal can 11 as the pressure within the metal can 11 decreases with the decrease in temperature.

Referring to FIG. 8 it should be understood that during operation of the induction heating system 10, metal cans 11 are continuously being loaded into the indexing drum 16 as the indexing drum 16 moves between stations. More specifically, once a first batch of metal cans 11 are loaded into a first pair of support arrangements 72 at the first position, the first pair of support arrangements (including the first catch of metal cans 11 located therein) are indexed to the second position. While the first batch of metal cans is at the first heating station 202a, a second batch of metal cans 11 are loaded into a second pair of support arrangements 72 that are located at the first position. Upon the next rotation, the first batch of metal cans 11 are at the second heating station 202b at the third position, the second batch of metal cans 11 are at the first heating station 202a at the second position, and a new, third batch of metal cans 11 are loaded into a third pair of support arrangements 72 at the first position. This cycle continues as the first batch of metal cans is indexed through the remaining stations (i.e. the third heating station 202c, the stabilizing station 204, and the three cooling stations 206a, 206b, and 206c, with a new batch of metal cans 11 being loaded in at the first position during each indexing of the index drum 16. Once the first batch of metal cans 11 cycles through all the stations and reaches the first position, the first batch of metal cans 11 is unloaded, and a new batch of metal cans 11 is loaded.

Referring to FIG. 9, a method for induction heating batches of sealed, metal cans 11 containing content which creates pressure in the metal cans 11 when the metal cans 11 are heated is provided, according to an exemplary embodiment. In one embodiment, at step 300 the sealed, metal cans 11 are inserted into the pressure chambers 40 at the first position. At step 302, electrical energy is applied to the induction coil 82 and coil segments 84 while simultaneously increasing the pressure in the pressure chambers 40 and agitating the metal cans 11 in the pressure chambers 40. At step 302, agitation of the metal cans 11 is performed by rotating the metal cans 11 that are located inside the holding tubes 87. The tube drive 150 controls the rotation of the metal cans 11 during step 302. At step 302, the induction coil 82 and coil segments 84 are cooled using a liquid, e.g., water. At step 304, electrical energy is removed from the induction coil 82 and coil segments 84. At step 306, after the electrical energy is removed, the pressure chambers 40 with the induction coil 82 and coil segments 84 are moved from the first position to the second position. At the second position, electrical energy is applied again to the induction coil 82 and coil segments 84 while the pressure chambers 40 are simultaneously being pressurized. At step 306, an additional second batch of sealed, metal cans 11 are inserted into additional pressure chambers 40 that also include an induction coil 82 and coil segments 84 that are both adjacent to the metal cans 11. The second batch of metal cans 11 are inserted into the additional pressure chambers 40 with the induction coil 82 and coil segments 84 while the pressure chambers 40 are located at the first position, which occurs at the same time the induction coil 82 and coil segments 84 of the pressure chambers 40 in which the first batch of metal cans 11 are loaded are applied with electrical energy at the second position. At step 308, electrical energy is applied to the second magnetic coil arrangement 166 while simultaneously increasing the pressure in the pressure chambers 40 and agitating the metal cans 11 in the pressure chambers 40. At step 308, agitation of the metal cans 11 is performed by rotating the metal cans 11 that are located inside the holding tubes 87. The drive 150 controls the rotation of the metal cans 11 during step 308. At step 308, simultaneously while electrical energy is being applied to the second magnetic coil arrangement 166, the metal cans 11 are cooled in the pressure chambers 40 having the first magnetic coil arrangement 164 with water while simultaneously reducing the pressure in the pressure chambers 40. At step 308, the second magnetic coil arrangement 166 is cooled using a liquid, e.g., water. At step 308, after electrical energy is applied, electrical energy is then removed from the second magnetic coil arrangement 166. At step 310, the metal cans 11 are removed from the pressure chambers 40 with the first magnetic coil arrangement 164 with the transfer device. At step 310, simultaneously while metal cans 11 are being removed from the pressure chambers 40 with the first magnetic coil arrangement 164, the metal cans 11 are cooled in the pressure chambers with the second magnetic coil arrangement 166 with water while simultaneously reducing the pressure in the pressure chambers 40. At step 312, the metal cans 11 are removed from the pressure chambers 40 with the second magnetic coil arrangement 166 with the transfer device.

In the shelf system, the loading and unloading would operate substantially the same as described immediately above. However, in the shelf system the loading/unloading station would index between the shelves of the system (e.g. between 8 shelves). The shelf system processes the cans as discussed above with respect to 8 stations with the exception being that the metal cans 11 are not moved between stations during processing. Rather, a shelf of metal cans 11 remains closed, the tubes 87 agitate and the heating, pressurization and cooling occur without moving the metal cans 11, holding tubes 87 and pressure chambers 40 between stations.

To provide adequate throughput for batch processing using induction heating, the system may use the indexing drum type transport system described above to support a plurality of pressure tubes 40 as described above. However, to avoid the complexity of the air, electrical and water connections involved in using a indexing drum, the indexing drum can be replaced with the shelf system described above. The shelf system would include multiple rows (e.g. 8 rows) of multiple can racks (e.g. 8 racks per row). Using 12 cans 11 per rack, the system would be typically be processing 8 batches of 96 cans or 768 during a complete cycle of the system. In this type of shelf system the metal cans 11 are batch processed row by row. In particular, the top row of can racks would be retracted from the system, loaded with cans and inserted back into the induction heating structure as discussed above in reference to the loading/unloading station 200 of FIG. 9. The racks of the shelf system would correspond in structure to the support arrangements 72 used in the indexing drum 16 embodiment. However, unlike in the indexing drum 16 embodiment, in which the electrical, water, and air connections for the support arrangements 72 are disconnected and reconnected at each station and each at each step (i.e. loading/unloading, heating, and cooling) of the MIH process, in the shelf embodiment, these connections would remain fixed at each step of the MIH process.

Upon insertion of a batch of metal cans 11 into the shelf system, the batch of metal cans 11 would be pressurized, heated and cooled in accordance with a heating/pressurization/cooling profile suitable for the can size and content. While the first batch/row is processed, the second row of metal cans 11 would be loaded and inserted into a second support arrangement 72 and processed. The system would cycle through the loading, inserting and processing steps for all rows, and then return to the top row where the process would also include an unloading step for the processed metal cans 11. Accordingly, when the system is running at steady state, the system continuously cycles through the unload, load, heat, pressurize and cool steps to provide high-throughput batch processing of metal cans 11. Using this system or a group of systems such as this, a packing plant will be able to process at typical commercial steam retort rates (e.g. 500-600 cans per minute).

In the shelf system, the pressure chambers 40 would be fabricated to withstand the pressures, temperatures and cycling stresses of the induction heating system 10. A structure useable for such chambers is a fiberglass reinforced epoxy tubes with o-ring seals for sealing the tubes at their respective ends.

As an alternative to a rotational system using an indexing drum 16 that rotates the metal cans 11 between the various stations of the MIH process, it is contemplated that the indexing drum 16 would be replaced with a shelf arrangement (not shown). In particular, support arrangements 72 would be supported within horizontally extending slot openings 66 generally having the form of horizontal shelves formed in a shelving unit. The system would include approximately 8 such slot openings/horizontal shelves into which the support arrangements 72 would be inserted in a drawer-like manner, and each support arrangement 72 would include 8 or more (e.g. 16-32) pressure chambers 40. This embodiment of the system will be referred to herein as the “shelf system.”

One advantage of the shelf system is that it is simpler to increase the number of pressure chambers 40 per support arrangement 72 which would increase the processing speed of the system. Additionally, in the indexing drum embodiment, each time the indexing drum 16 is indexed or rotated between stations, the input connections (e.g. electric, water, air, etc.) between the indexing drum 16 and the support arrangements 72 must be disconnected prior to indexing, and subsequently reconnected once the indexing drum 16 has indexed/rotated to the next station. With the shelf system, instead of moving the support arrangements 72 between stations each located at 45° from each other, the support arrangements 72 would remain stationary within the shelving unit. Similar to the indexing drum embodiment, connected between each support arrangement 72 and the shelving unit would be a series of input connections (e.g. electric, water, air, etc.). However, unlike in the indexing drum embodiment, with the shelf system there would be no need to physically disconnect the input connections between the support arrangements 72 and the shelving unit between each of the stages (i.e. loading/unloading, heating, stabilizing, and cooling) of the MIH process. Instead, the shelf system would be configured to switch the various connections on and off as each of the various inputs are needed during the various stages of the MIH process.

1. A system for heating batches of sealed, metal cans containing a content such as a food product, the system comprising:
a pressure chamber having an opening;
an induction coil supported within the pressure chamber;
a can support for engaging and rotating a plurality of sealed, metal cans, at least a portion of the can support being movable through the opening from a first position outside of the chamber to a second position within the chamber adjacent to the induction coil and being rotatably supported within the chamber;
a sealing device which seals the pressure chamber when the can support is within the chamber;
a power supply coupled to the induction coil to energize the coil to apply an alternating current to the coil to induce a current into the metal cans which heats the content of the metal cans;
an air pressure source coupled to the pressure chamber to pressurize the chamber during energization of the induction coil; and
a drive coupled to the can support which rotates the can support during energization of the induction coil.

2. (canceled)

3. The system of claim 1, further comprising:
at least one water nozzle located within the chamber; and
a cooling water source coupled to the water nozzle to cool cans located within the chamber.

4. The system of claim 1, wherein the induction coil includes a plurality of coil segments each configured to heat one or more cans located adjacent to the segment.

5. The system of claim 1, wherein the can support includes a first perforated half-tube and a second perforated half-tube, the half-tubes being of substantially the same length and being slidably engageable to form a closed perforated tube which captures the of sealed, metal cans, the first perforated half-tube being rotatably supported within the chamber by the drive and the second perforated half-tube being the portion of the can support removable from the pressure chamber and being rotatably supported by the sealing device such that when the sealing device is moved from the pressure chamber the second perforated half-tube and cans supported thereby are removed from the pressure chamber with the second perforated half-tube remaining slidably engaged with the first perforated half-tube.

6. The system of claim 5, further comprising a transfer device for placing cans on, and removing cans from, the second perforated half-tube when removed from the pressure chamber.

7. The system of claim 6, wherein the pressure chamber is a tube including a longitudinal axis, the system further comprising a wheel assembly rotatable about a rotational axis between a plurality of locations including a heating station and a loading station, wherein the wheel assembly supporting the pressure chambers with the longitudinal axes parallel to the rotational axis to move the tube between locations, the transfer device being supported relative to the wheel assembly to place cans on the second perforated half-tube when the pressure chamber is at the loading station, the sealing device being sealable with the pressure chamber at the loading station, the pressure chamber being pressurizable at the heating station, and the induction coil being energizeable at the heating station.

8. A system for heating batches of sealed, metal cans containing a food product, the system comprising:
a first plurality of heating induction heating arrangements for each heating a plurality of sealed, metal cans, each arrangement including:
a pressure chamber having an opening;
an induction coil supported within the pressure chamber;
a can support for engaging and rotating the sealed, metal cans, at least a portion of the can support being movable through the opening from a first position outside of the chamber to a second position within the chamber adjacent to the induction coil and being rotatably supported within the chamber; and
a sealing device which seals the pressure chamber when the can support is within the chamber;
a power supply coupled to the induction coils to energize the coils to apply an alternating current to the coils to induce a current into the metal cans which heats the content of the metal cans;
an air pressure source coupled to the pressure chambers to pressurize the chambers during energization of the induction coil; and
a drive system coupled to the can supports to rotate the can supports during energization of the induction coils.

9. The system of claim 8, further comprising a support arrangement which supports the heating arrangements in a spaced, side-by-side orientation.

10. The system of claim 8, wherein the induction coils each include a cooling channel and the system includes a cooling water source coupled to the cooling channels to cool the coils.

11. (canceled)

12. (canceled)

13. The system of claim 9, wherein the can supports each includes a first perforated half-tube and a second perforated half-tube, the half-tubes being of substantially the same length and being slidably engageable to form a closed perforated tube which captures the sealed, metal cans, the first perforated half-tubes being rotatably supported within respective chambers by the drive system and the second perforated half-tubes being the portion of the can supports removable from the pressure chambers and being rotatably supported by the respective sealing devices such that when the sealing devices are moved from the respective pressure chambers the second perforated half-tubes and cans supported thereby are removed from the respective pressure chambers with the second perforated half-tubes remaining slidably engaged with the respective first perforated half-tubes.

14. (canceled)

15. The system of claim 13, wherein the pressure chambers are tubes each including a longitudinal axis, the system further comprising a wheel assembly rotatable about a rotational axis between a plurality of locations including a heating station and a loading station, the wheel assembly being attached to the support arrangement such that the longitudinal axes are parallel to the rotational axis and the longitudinal axes are spaced radially from the rotational axis, the support arrangements being moveable by the wheel assembly between locations, the transfer device being supported relative to the wheel assembly to place cans on the second perforated half-tubes when the pressure chambers are at the loading station, the sealing devices being sealable with the pressure chambers at the loading station, the pressure chambers being pressurizable at the heating stations, and the induction coils being energizeable at the heating station.

16. The system of claim 8, further comprising:
a second plurality induction heating arrangements for each heating a plurality of sealed, metal cans, each arrangement including:
a pressure chamber having an opening;
an induction coil supported within the pressure chamber;
a can support for engaging and rotating a plurality of sealed, metal cans, at least a portion of the can support being movable through the opening from a first position outside of the chamber to a second position within the chamber adjacent to the induction coil and being rotatably supported within the chamber; and
a sealing device which seals the pressure chamber when the can support is within the chamber;
the power supply coupled to the induction coils to energize the coils to apply an alternating current to the coils to induce a current into the metal cans which heats the content of the metal cans;
the air pressure source coupled to the pressure chambers to pressurize the chambers during energization of the induction coil; and
the drive system coupled to the can supports to rotate the can supports during energization of the induction coils.

17. The system of claim 16, further comprising:
first and second support arrangements which support respective first and second plurality of the heating arrangements in a spaced, side-by-side orientation wherein the can supports each includes a first perforated half-tube and a second perforated half-tube, the half-tubes being of substantially the same length and being slidably engageable to form a closed perforated tube which captures the of sealed, metal cans, the first perforated half-tubes being rotatably supported within respective chambers by the drive system and the second perforated half-tubes being the portion of the can supports removable from the pressure chambers and being rotatably supported by the respective sealing devices such that when the sealing devices are moved from the respective pressure chambers the second perforated half-tubes and cans supported thereby are removed from the respective pressure chambers with the second perforated half-tubes remaining slidably engaged with the respective first perforated half-tubes;
a transfer device for placing cans on, and removing cans from, the second perforated half-tubes when removed from the respective pressure chambers; and
a control system for controlling the transfer device and the power supply to remove or place cans on the second perforated half-tubes of the first inducting heating arrangement while power is supplied to the induction coils in the second induction heating arrangement.

18. The system of claim 17, including a frame for supporting the first arrangement in a parallel relationship to the second arrangement with all of the longitudinal axes being parallel.

19. A method for induction heating batches of sealed, metal cans containing content which creates pressure in such cans when the cans are heated, the method including the steps of:
inserting a plurality of metallic cans into a first pressure chamber including a first magnetic coil arrangement located adjacent to the sealed cans, the chamber being located at a first location;
applying electrical energy to the first magnetic coil arrangement while simultaneously increasing the pressure in the pressure chamber and agitating the cans in the pressure chamber;
removing electrical energy from the first magnetic coil arrangement;
cooling the cans with water while simultaneously reducing the pressure in the pressure chamber; and
removing the cans from the pressure chamber.

20. The method of claim 19, wherein the step of applying electrical energy includes cooling the first magnetic coil arrangement with a liquid.

21. The method of claim 19, wherein agitating the cans is performed by rotating the cans.

22. The method of claim 19, wherein after the step of removing electrical energy, the first pressure chamber is moved to a second location and electrical energy is applied to the first magnetic coil arrangement while the pressure chamber is pressurized.

23. The method of claim 20, further including the steps of:
inserting a plurality of metallic cans into a second pressure chamber including a second magnetic coil arrangement located adjacent to the sealed cans;
applying electrical energy to the second magnetic coil arrangement while simultaneously increasing the pressure in the second pressure chamber, agitating the cans in the second pressure chamber, and cooling the cans in the first pressure chamber;
removing electrical energy from the second magnetic coil arrangement;
cooling the cans in the second pressure chamber with water while simultaneously reducing the pressure from the second pressure chamber; and
removing the cans from the second pressure chamber.

24. The method of claim 23, wherein the step of applying electrical energy includes cooling the second magnetic coil arrangement with a liquid.

25. (canceled)
